(19) United States
(12) Patent Application Publication
(10) Pub. No.: US 2021/0368392 A1
(43) Pub. Date: Nov. 25, 2021

(54) METHOD AND APPARATUS FOR LOAD BALANCING IP ADDRESS SELECTION IN A NETWORK ENVIRONMENT

(71) Applicant: NOKIA TECHNOLOGIES OY, Espoo (FI)

(72) Inventor: Juha-Matti TILLI, Espoo (FI)

(73) Assignee: NOKIA TECHNOLOGIES OY, Espoo (FI)

(21) Appl. No.: 16/467,567

(22) PCT Filed: Dec. 9, 2016
(86) PCT No.: PCT/IB2016/057511

§ 371 Date: Jun. 7, 2019

(51) Int. Cl. H04W 28/08; H04L 12/743; H04L 29/12; H04W 76/12

(52) U.S. Cl. CPC H04W 28/09; H04W 76/12; H04L 61/2007; H04L 45/7453

(57) ABSTRACT

A method, apparatus and computer program product are provided for the efficient distribution of tunneled packets associated with multiple pieces of user equipment across central processing unit cores associated with network components. Example implementations contemplate one or more network components, such as a NodeB or gateway, which are configured with multiple IP addresses associated with multiple cores or other processors within the network component. In such example implementations, tunnels may be initialized to network endpoints such that network traffic loads imposed on the network component can be balanced by selecting one or more IP addresses from amongst the plurality of IP addresses associated with the particular network component.

### TECHNICAL FIELD

An example embodiment relates generally to wireless network access technology, particularly in the context of providing for the efficient distribution of tunneled packets associated with multiple pieces of user equipment across central processing unit cores associated with network components.

### BACKGROUND

Recent improvements in the capabilities of mobile devices and the networks within which such mobile devices operate have allowed mobile devices to become ubiquitous and essential tools that are used by individuals to improve many facets of their lives. The widespread adoption of modern mobile devices has given rise to expectations amongst users that the network used with such devices will always operate in a manner that permits high user data rates and reliable performance.

While networks are typically designed to be able to meet user expectations and demands, the high user data rates expected by network users, particularly in areas where multiple users are attempting to access a network from a particular location, can often overload and otherwise exceed the capacity of individual network components, causing decreased network performance and other undesired effects. Particularly when viewed in light of the degree to which users of mobile devices rely on consistent, high-performing network service, the ability of a network to handle high-volume network traffic and high user data rates poses a number of challenges. The inventor of the invention disclosed herein has identified these and other technical challenges, and developed the solutions described and otherwise referenced herein.

### BRIEF SUMMARY

A method, apparatus and computer program product are therefore provided in accordance with an example embodiment in order to provide for the efficient distribution of tunneled packets associated with multiple pieces of user equipment across central processing unit cores associated with network components. In this regard, the method, apparatus and computer program product of an example embodiment provide for the establishment of one or more network components, such as NodeBs, user plane gateways, and/or other network endpoints or other components, with multiple IP addresses, and routing traffic through the multiple IP addresses.

In an example embodiment, a method for selecting an endpoint IP address for a tunnel associated with a user equipment or a flow is provided, the method comprising receiving an identification of an IP address, wherein the IP address is one of a plurality of IP addresses associated with an endpoint within a network; initializing a tunnel associated with a user equipment device, wherein initializing the tunnel comprises selecting the IP address; and transmitting a packet via the tunnel to the IP address associated with the endpoint within the network. In some example implementations of such a method, the endpoint is a NodeB. In some example implementations, the endpoint is a user plane gateway.

In some example implementations of such a method, selecting the IP address comprises applying a load balancing selection protocol. In some such example implementations, and in other example implementations, selecting the IP address comprises applying a hash function. In some such example implementations, and in other example implementations, selecting the IP address comprises applying a round robin selection protocol.

In some example implementations of such a method, receiving an identification of an IP address, wherein the IP address is one of a plurality of IP addresses associated with an endpoint within a network comprises calculating an IP address based at least in part on an identifier associated with a user equipment or a flow. In some such example implementations, and in other example implementations, transmitting a packet via the tunnel to the IP address associated with the endpoint within the network comprises applying an identifying header field, wherein the identifying header field comprises at least one of an identification of an IP address, an identification of a port, or an identification of an IPv6 flow label.

In another example embodiment, an apparatus is provided that includes at least one processor and at least one memory that includes computer program code with the at least one memory and the computer program code configured to, with the at least one processor, cause the apparatus to at least receive an identification of an IP address, wherein the IP address is one of a plurality of IP addresses associated with an endpoint within a network; initialize a tunnel associated with a user equipment device, wherein initialize the tunnel comprises selecting the IP address; and transmit a packet via the tunnel to the IP address associated with the endpoint within the network. In some example implementations of such an apparatus, the endpoint is a NodeB. In some example implementations of such an apparatus, the endpoint is a user plane gateway.

In some example implementations of such an apparatus, selecting the IP address comprises applying a load balancing selection protocol. In some such example implementations, and in other example implementations, selecting the IP address comprises applying a hash function. In some such example implementations, and in other example implementations, selecting the IP address comprises applying a round robin selection protocol.

In some example implementations of such an apparatus, receiving an identification of an IP address, wherein the IP address is one of a plurality of IP addresses associated with an endpoint within a network comprises calculating an IP address based at least in part on an identifier associated with the user equipment device or a flow. In some such example implementations, and in other example implementations, transmitting a packet via the tunnel to the IP address associated with the endpoint within the network comprises applying an identifying header field, wherein the identifying header field comprises at least one of an identification of an IP address, an identification of a port, or an identification of an IPv6 flow label.

In a further example embodiment, a computer program product is provided that includes at least one non-transitory computer-readable storage medium having computer-executable program code instructions stored therein with the computer-executable program code instructions including program code instructions configured to at least receive an identification of an IP address, wherein the IP address is one of a plurality of IP addresses associated with an endpoint within a network; initialize a tunnel associated with a user equipment device, wherein initialize the tunnel comprises selecting the IP address; and transmit a packet via the tunnel to the IP address associated with the endpoint within the network. In some example implementations of such a computer program product, the endpoint is a NodeB. In some example implementations of such a computer program product, the endpoint is a user plane gateway.

In some example implementations of such a computer program product, selecting the IP address comprises applying a load balancing selection protocol. In some such example implementations, and in other example implementations, selecting the IP address comprises applying a hash function. In some such example implementations, and in other example implementations, selecting the IP address comprises applying a round robin selection protocol.

In some example implementations of such a computer program product, receiving an identification of an IP address, wherein the IP address is one of a plurality of IP addresses associated with an endpoint within a network comprises calculating an IP address based at least in part on an identifier associated with the user equipment device or a flow. In some such example implementations, and in other example implementations, transmitting a packet via the tunnel to the IP address associated with the endpoint within the network comprises applying an identifying header field, wherein the identifying header field comprises at least one of an identification of an IP address, an identification of a port, or an identification of an IPv6 flow label.

In yet another example embodiment, an apparatus is provided that includes means for receiving an identification of an IP address, wherein the IP address is one of a plurality of IP addresses associated with an endpoint within a network; initializing a tunnel associated with a user equipment device, wherein initializing the tunnel comprises selecting the IP address; and transmitting a packet via the tunnel to the IP address associated with the endpoint within the network. In some example implementations of such an apparatus, the endpoint is a NodeB. In some example implementations, the endpoint is a user plane gateway.

In some example implementations of such an apparatus, the apparatus further includes means for selecting the IP address by at least applying a load balancing selection protocol. In some such example implementations, and in other example implementations, the apparatus includes means for selecting the IP address by at least applying a hash function. In some such example implementations, and in other example implementations, the apparatus includes means for selecting the IP address by at least applying a round robin selection protocol.

In some example implementations of such an apparatus, the apparatus includes means for receiving an identification of an IP address, wherein the IP address is one of a plurality of IP addresses associated with an endpoint within a network by at least calculating an IP address based at least in part on an identifier associated with a user equipment or a flow. In some such example implementations, and in other example implementations, transmitting a packet via the tunnel to the IP address associated with the endpoint within the network comprises applying an identifying header field, wherein the identifying header field comprises at least one of an identification of an IP address, an identification of a port, or an identification of an IPv6 flow label.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 depicts an example system environment in which implementations in accordance with an example embodiment of the present invention may be performed;

FIG. 2 is a block diagram of an apparatus that may be specifically configured in accordance with an example embodiment of the present invention;

FIG. 3 depicts a block diagram of an arrangement of network components structured and otherwise arranged to operate in accordance with an example embodiment of the present invention;

FIG. 4 depicts another block diagram of an arrangement of network components structured and otherwise arranged to operate in accordance with an example embodiment of the present invention;

FIG. 5 depicts another block diagram of an arrangement of network components structured and otherwise arranged to operate in accordance with an example embodiment of the present invention;

FIG. 6 depicts another block diagram of an arrangement of network components structured and otherwise arranged to operate in accordance with an example embodiment of the present invention;

FIG. 7 depicts a block diagram of a network component in operation in accordance with an example embodiment of the present invention; and

FIG. 8 is a flowchart illustrating a set of operations performed, such as by the apparatus of FIG. 2, in accordance with an example embodiment of the present invention.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As used herein, a “computer-readable storage medium,” which refers to a non-transitory physical storage medium (for example, volatile or non-volatile memory device), can be differentiated from a “computer-readable transmission medium,” which refers to an electromagnetic signal.

As used herein, the term “flow” may refer to packets having the same inner packet IP addresses and/or ports (if present), packets having the same IP version 6 (IPv6) flow label, and/or packets belonging to the same bearer in fourth generation (4G) long-term evolution (LTE) and/or evolved packet core (EPC) systems, or the like.

A method, apparatus and computer program product are provided in accordance with example embodiments in order to provide for the efficient distribution of tunneled packets associated with multiple pieces of user equipment across central processing unit cores associated with network components. Many particularly advantageous implementations of the embodiments of the invention disclosed herein are aimed at providing for the efficient distribution of tunneled packets that are sent over a wireless network, particularly in situations where one or more network components are configured to allow for the use of multiple packet queues.

Mobile network performance, and the demands for such performance, has increased significantly. While many second generation (2G) networks were able to support transmission rates of approximately 100 kbits/s, some estimates suggest that fifth generation (5G) networks will be able to support transmission rates of 10 Gbit/s or more. As such, the rate of increase in network performance has, by at least some metrics, been much faster than the rate of increase in the processing power of the central processing units (CPUs) used in many network components. This mismatch in the rate of performance improvement has raised a number of technical challenges when designing and implementing components capable of operating within a network at the data rates expected of the network. At least some of these technical challenges have been compounded as the rate of improvement in the per-core performance of CPUs has fallen below the rate which historical evidence would have predicted.

In order to overcome mismatches between individual CPU performance capabilities and network demands, many network components have been designed to incorporate multiple CPU cores into a single microprocessor in a manner that allows for the use of parallel processing of data received by the network component. Most conventional, modern central processing units (CPUs) associated with network components currently incorporate multiple cores. If network traffic was handled by only one core, the single core could easily be overloaded given the 10 Gbit/s-40 Gbit/s rates that are available in many high-speed networks. Therefore, many network interface card (NIC) vendors have added support for multiple packet queues to their NICs.

However, the use of multiple cores raises additional technical challenges. For example, to take advantage of the parallel processing capabilities of multiple cores, the algorithms used by network components must be modified. Typically, these modifications tend to require the use of multiple packet processing threads. However, the use of multiple packet processing threads itself also raises a number of technical challenges. One significant technical challenge that arises in NICs that employ multiple cores is the problem of deciding how to distribute particular packets amongst the available queues. One possible approach involves the use of round-robin scheduling. However, round-robin scheduling may be undesirable in some situations, because such scheduling may result in packets belonging to a particular transmission control protocol (TCP) flow being distributed to different CPU cores. This, in turn, may cause the packets to become reordered in a manner that decreases TCP performance in an undesired manner. Consequently, in many situations, packets are hashed to different cores based on IP addresses, and, in some instances, TCP and/or user datagram protocol (UDP) ports. In some such hash-based situations, a hash function is calculated, wherein such hash function may take the form of hash(srcip, dstip, srcport, dstport, queuecount), for example.

In some situations, tunneling protocols are used that run directly on top of an implementation of Internet protocol (IP), instead of having UDP in between IP and the tunneling protocol. In such situations, the tunneling protocols typically do not use ports, and the packet hashing is therefore based primarily on IP addresses. Regardless of the precise implementation of the tunneling protocol, most tunneling protocols have a key field, which may be referred to as a “key” (such as in generic routing encapsulation (GRE)), “tunnel endpoint identifier” (TEID) (such as in general packet radio service (GPRS) tunneling protocol (GTP)), and a “virtual network identifier” (VNI) (such as in virtual extensible local area network (LAN), (VXLAN)). In general, this key field serves to identify the piece of user equipment and/or the flow to which a particular packet belongs.

However, conventional network interface cards are not configured to be able to use the key field to hash packets to different cores. Consequently, in portions of a network where multiple pieces of user equipment (UE) interface with an single base station (BS) and a single gateway (GW), the tunnel between the base station and the gateway uses a single endpoint IP address, which causes all of the packets from all of the pieces of user equipment to be routed to the same CPU core, and thus limiting the effective data rate of the portion of the network to that of one CPU core.

This same problem can arise in situations where a NodeB has only one IP address for user plane data, where a user plane gateway (UGW) has only one IP address for user plane data, and/or where tunneling protocols are used that do not use ports (such as GRE, for example) or where the ports are fixed (such as 2152, as in GTP, for example). In such situations, the packet hashing engines used to distribute data see the single IP address and/or port identifications, and consequently cause the all of the packets sent to a particular NodeB to be hashed to a single core, regardless of whether the NodeB has other cores capable of processing the packets. This in turn can limit the throughput of the NodeB to the capabilities of a single core.

The technical issues caused and/or associated with inefficiently directing packets to a single core are exacerbated in situations where high network data rates are required. For example, the 10 Gbps per UE performance requirement associated with 5G networks may be increased with massive multiuser, multiple-input/multiple-output (MU-MIMO) arrangements by employing sixty-four antennas to theoretically aggregate rates of 640 Gbps per sector. Regardless of the precise deployment of antennas and other network components, some example network configurations contemplate data rates on the order of tens or low hundreds of gigabits per second. These high data rates require the use of multiple threads, as the upper limit on the processing capabilities of one thread is approximately 15 Gbps in some example situations that use recent technology, such as Intel's data plate development kit (DPDK), netmap, PF_RING, or a wrapper, such as OpenDataPlane (ODP). In situations that rely on an operating system's TCP/IP stack, the maximum data rate may be further limited to between 5 Gbps and 8 Gbps per thread. As such, the data rates associated with these single-thread limits are likely to be insufficient to meet the typical total aggregate data rate demands in 5G network environments.

Many of the technical challenges described and otherwise contemplated herein share a common cause in that if packets of one NodeB or other network component typically are routed to the same core when conventional hashing engines are used, the throughput of a particular NodeB is limited by the throughput that one core can sustain. Consequently, the inventors herein have recognized that these technical challenges can be addressed by improving the aggregate throughput of a NodeB, gateway, and/or other network component.

While field programmable gate arrays (FPGAs) or application specific integrated may be used in some situations to improve the throughput of a NodeB, such approaches have significant drawbacks, at least in the sense that they are typically less flexible than CPUs and have higher development costs.

To address these, and other technical challenges, some example implementations of embodiments of the present invention provide for the efficient distribution of tunneled packets associated with multiple pieces of user equipment across central processing unit cores associated with network components. In example implementations that involve a NodeB and/or a UGW, the efficient distribution of tunneled packets in a manner that increases the throughput of the NodeB and/or UGW beyond that of a single core is accomplished by configuring the NodeB and/or UGW to have multiple IP addresses. In some such example implementations, when a tunnel is set up with the NodeB and/or UGW, a hash value may be calculated based at least on a UE identifier, and the IP address to be used is selected based on the hash value.

Some example implementations of embodiments of the invention may include calculating a hash value based on the UE identifier when setting up a tunnel, and selecting a particular IP address from amongst a plurality of IP addresses associated with the NodeB end based on the hash value. In such implementations that arise in a MU-MIMO environment, particularly those that may be implemented in the context of a 5G network protocol or other protocol using GRE as a tunneling protocol, very high aggregate throughputs for a single NodeB serving multiple pieces of user equipment may be achieved.

As described and otherwise contemplated herein, example implementations of embodiments of the invention contemplate configuring a network endpoint, such as a base station end or a gateway end, to have multiple IP addresses. In some example implementations, both a base station end and related gateway end may be configured to have multiple IP addresses. In some situations, it may be particularly advantageous to configure a NodeB or other network component such that one flow of a particular piece of user equipment always uses the same IP address pair, such that packets are not reordered. In some such implementations, handovers and/or gateway relocations can cause a change in the IP pair on either end.

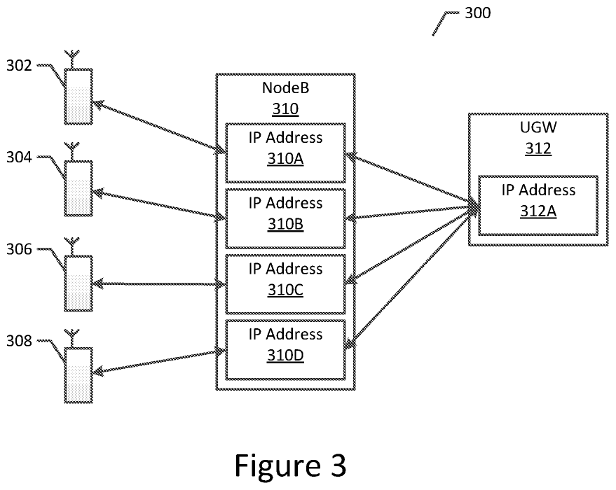

One example arrangement of network components structured and otherwise arranged to operate in accordance with an example embodiment of the present invention is presented in FIG. 3. As shown in FIG. 3, network portion 300 includes multiple pieces of user equipment 302, 304, 306, and 308, a NodeB 310, and a user plane gateway (UGW) 312. While only four pieces of user equipment are shown in FIG. 3 for the purposes of clarity, it will be appreciated that network portion 300 and/or other similar implementations may include any number of pieces of user equipment. As shown in FIG. 3, NodeB 310 is configured to have multiple IP addresses 310A, 310B, 310C, and 310D. While NodeB 310 is depicted in FIG. 3 as having four IP addresses 310A-310D for the purposes of clarity, it will be appreciated that NodeB 310 may be configured with any number of IP addresses, and that the number of IP addresses associated with NodeB 310 does not need to match the number of pieces of user equipment served by NodeB 310.

As shown in FIG. 3, each piece of user equipment 302, 304, 306, and 308 is configured to communicate with NodeB 310 such that each piece of user equipment uses a single IP address to communicate with NodeB 310, but NodeB itself is configured to have multiple IP addresses, such that NodeB is able to process the packets received from the pieces of user equipment 302, 304, 306, and 308 in parallel, using multiple cores. The selection of endpoint IP addresses for a particular piece of user equipment or flow can occur at the time of user equipment and/or flow initialization, or can occur through the use of a hash function that involves fields that remain the same for a given flow, such as the UE identifier, bearer identifier, international mobile subscriber identity (IMSI), tunnel endpoint identifier (TED), inner packet IP addresses, inner packet ports, and/or IPv6 flow label, for example. Consequently, the throughput available from NodeB 310 is not limited to the available throughput of a single core, but is instead the aggregate throughput of each core implicated by the multiple IP addresses of NodeB 310.

As shown in FIG. 3, NodeB 310 is able to communicate with UGW 312, which is shown with single IP address 312A, by passing all of the packets received from the pieces of user equipment 302, 304, 306, and 308 at IP addresses 310A-310D, to UGW 312 at IP address 312A. It will be appreciated that UGW 312 is also capable of transmitting packets to NodeB 310 by directed packets to any of the IP addresses associated with NodeB 310.

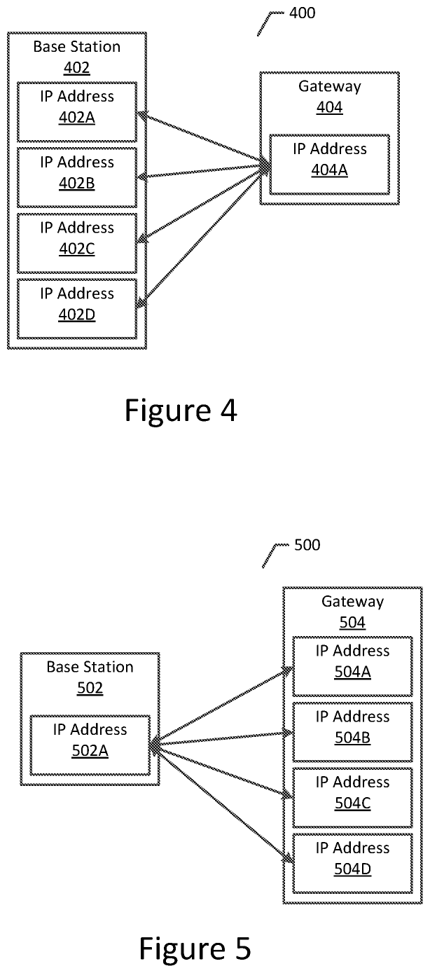

As noted herein, some example implementations of embodiments of the invention disclosed herein contemplate base stations and/or gateways configured with multiple IP addresses. Network portions that reflect some such arrangements are depicted in FIGS. 4, 5, and 6. As shown in FIG. 4, network portion 400 includes a base station 402 that is configured with multiple IP addresses 402A, 402B, 402C, and 402D. Network portion 400 also includes a gateway 404 with a single IP address 404A. In the example arrangement depicted in FIG. 4, base station 402 and gateway 404 are arranged such that packets can be directed from any of IP addresses 402A-402D associated with base station 402 to IP address 404A associated with gateway 404. Likewise, packets can be directed from IP address 404A associated with gateway 404 to any of the IP addresses 402A-402D associated with base station 402 as may be called for in a given network arrangement or situation.

As shown in FIG. 5, network portion 500 includes a base station 502 that is configured with a single IP address 502A and a gateway 504 that is configured with multiple IP addresses 504A-504D. As with the arrangements in shown in FIGS. 3 and 4, the base station 502 and the gateway 504 in network portion 500 are arranged and in communication such that packets can be directed from any of IP addresses 504A-504D associated with gateway 504 to IP address 502A associated with base station 502. Likewise, packets can be directed from IP address 502A associated with base station 502 to any of the IP addresses 504A-504D associated with gateway 504 as may be called for in a given network arrangement or situation.

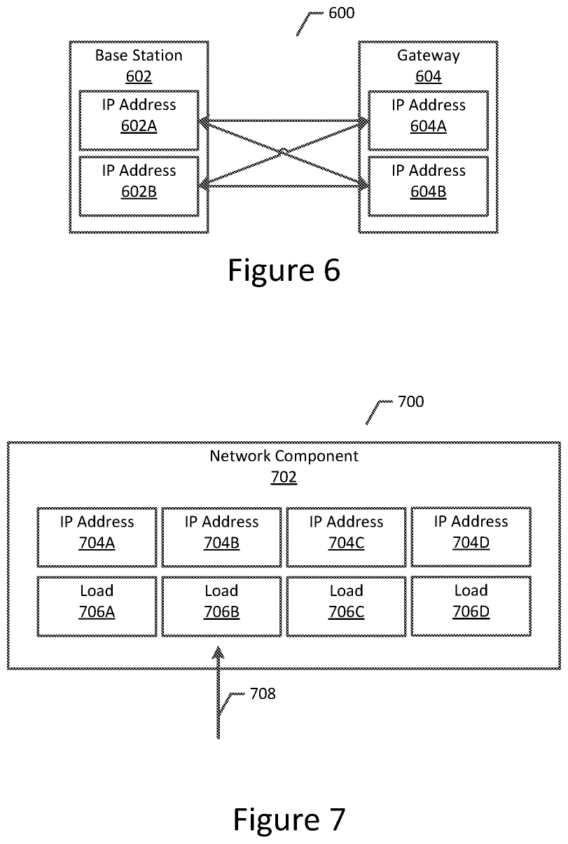

As shown in FIG. 6, network portion 600 includes a base station 602 that is configured to have multiple IP addresses 602A and 602B. Network portion 600 also includes a gateway 604 that is configured to have multiple IP addresses 604A and 604B. Similar to the arrangements depicted in FIGS. 3, 4, and 5, base station 602 and gateway 604 are arranged and in communication such that packets can be directed to and/or from any of the IP addresses 602A-602B associated with base station 602 from and/or to any of the IP addresses 604A-604B associated with gateway 604.

Regardless of the precise configuration of network components and the number of multiple IP addresses assigned to a given network component, some example implementations of embodiments of the invention disclosed herein contemplate the use of tunneling in network environments and/or portions of network environments in a manner that allows for parallel processing of packets received from and/or directed to multiple pieces of user equipment. In some such example implementations, it may be particularly advantageous, when initializing a tunnel, to select the least-used endpoint IP address for the end having multiple IP addresses, such that the load amongst IP addresses and their related cores at the endpoint or other network component can be balanced, in the sense that load and/or other demand placed on the endpoint or other network component can be distributed equally, near equally, or in accordance with other balancing parameters amongst the cores or other processors associated with the relevant IP addresses. Such load balancing may be particularly advantageous in situations where the number of pieces of user equipment exceeds the number of IP addresses available at a network component, particularly to the extent that the load balancing approach tends to prevent the overloading of any one core until the entire network endpoint and/or other network component is at or near its full capacity.

FIG. 7 depicts network portion 700, which includes network component 702. In some example implementations, network component 702 may be a base station, NodeB, UGW, other gateway, or another network component that is capable of having multiple IP addresses and routing packets and/or other network traffic through such multiple IP addresses. As shown in FIG. 7, network component 702 is configured with multiple IP addresses, 704A, 704B, 704C, and 704C, each of which has a corresponding load, 706A, 706B, 706C, and 706D. At a time when a tunnel is to be initialized, network component 702 is capable of identifying the loads associated with each of its IP addresses, and determining which IP address is associated with the core or other processor that has the lowest load at a given point in time. As shown by selection indicator 708, the IP address associated with the lowest load (IP address 704B, with load 706B in the example depicted in FIG. 7), is selected, and used in connection with the initialization of the tunnel. Subsequently, the load associated with the selected IP address (and the other IP addresses associated with network component 702) can be updated to reflect any changes in load and/or relative load amongst the IP addresses 704A-704D.

In some example implementations, such balancing can be accomplished by tracking, at the endpoint or other network component that is configured with multiple IP addresses, the usage counts and/or other load metric of the IP addresses and informing the other end of the least-burdened IP address. Subsequently, a selection routine or other protocol may output the chosen IP address and allow for the usage count statistics to be updated.

In some such example implementations, after the selection of a particular IP address, an entry for a tunnel may is initialized. In some example implementations, this may be accomplished in part by a gateway conducting a query to ascertain the entry by tunnel endpoint identifier (TEID) and/or, such as in the case of an Internet-facing gateway, by IP address. In some situations, a base station may be able to identify the entry of the tunnel by user equipment (UE) identifier and/or by TEID. In such example implementations, the tunnel entry is capable of (and configured to) store the endpoint IP addresses of the tunnel.

In such example implementations, when a tunneled packet arrives to a tunnel endpoint that is configured with multiple IP addresses, an initial hash table lookup may be performed to reject packets directed to incorrect destination IP addresses that are not used by the particular endpoint. It may also be advantageous to subsequently conduct a query or a lookup based on TEID. Likewise, in many example implementations, the endpoint also checks the destination IP address (and, in some cases, the source IP address). In the case of a single IP address end, an IP address check may be performed for the destination IP address by equality, and a TEID lookup may be subsequently performed. Likewise, in some instances, the source IP address may be checked using an equality check.

Regardless of the precise configuration of the components associated with the tunnel, upon transmission of a packet, the tunnel entry may be looked up and the IP address and/or addresses associated with the particular tunnel entry can be used.

In some alternative example implementations, the IP address to be selected and used with a particular tunnel can be recalculated for every instance. In some such implementations, it may be advantageous to compute the IP address based at least in part on the relevant IMSI, other UE identifier, TED, and/or other similar UE or flow-identifying field.

It will be appreciated that in some example implementations, a particular entry may contain and/or be associated with an optional additional IP address. In situations where the optional additional IP address is present, that IP address may be used in accordance with the embodiments of the invention described and otherwise contemplated here. In situations where the optional additional IP address is not present and/or otherwise unavailable, the default IP address associated with the entry may be used.

It will also be appreciated that, as contemplated here, each entry associated with a tunnel may have a set of IP addresses per endpoint. Consequently, in some situations, the set may not be a singleton set, and therefore require the selection of one IP address from amongst a plurality of IP addresses for a given endpoint. In some such situations, the IP address may be selected from a given set based on a hash function that may be calculated, for example, from inner packet IP addresses, ports, and/or from IPv6 addresses and/or flow labels. In some such situations, a single UE may be able to realize higher user data rates through the use of multiple TCP connections, especially if the realized aggregate data rate for the particular UE outweighs the potential decrease in per-core performance triggered by the additional hash function calculation burden.

As described and otherwise contemplated herein, example implementations of embodiments of the invention permit improved base station performance and, in the case of gateways that communicate with more than one base station, gateway performance, particularly in situations where the base stations and/or gateway is configured in a manner that allows for increased parallel processing to translate into increased aggregate user data rates. It will be appreciated that, in some instances, the effect of packets crossing non-uniform memory architecture (NUMA) node boundaries may be detected as a slight decrease in performance as the number of IP addresses for a given network component is increased, it will be appreciated that such effects can typically be overcome through the addition of even more IP addresses and/or cores to increase the parallel processing capability of the component and the related thread count.

It will be appreciated that many of the example implementations described herein are expressed such that they refer to IP addresses within a network environment. However, it will be appreciated that other network protocol addresses may be used in example implementations of embodiments of the invention. For example, if a network and/or portion of a network was configured in a manner that did not conform to a protocol that uses IP addresses, example implementations of embodiments of the invention may use the particular network protocol address used in such network environments.

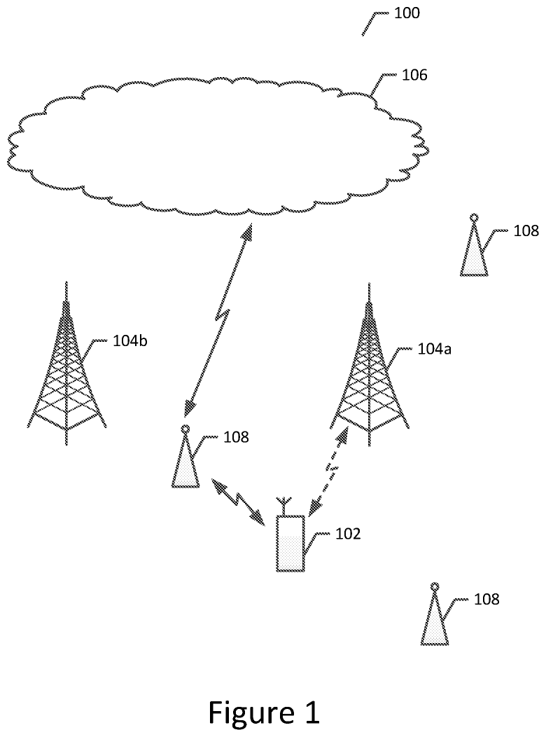

While the method, apparatus and computer program product of an example embodiment may be deployed in a variety of different systems, one example of a system that may benefit from the distribution of packets and/or other load balancing discussed and contemplated herein in accordance with an example embodiment of the present invention is depicted in FIG. 1. The depiction of system environment 100 in FIG. 1 is not intended to limit or otherwise confine the embodiments described and contemplated herein to any particular configuration of elements or systems, nor is it intended to exclude any alternative configurations or systems for the set of configurations and systems that can be used in connection with embodiments of the present invention. Rather, FIG. 1, and the system environment 100 disclosed therein is merely presented to provide an example basis and context for the facilitation of some of the features, aspects, and uses of the methods, apparatuses, and computer program products disclosed and contemplated herein. It will be understood that while many of the aspects and components presented in FIG. 1 are shown as discrete, separate elements, other configurations may be used in connection with the methods, apparatuses, and computer programs described herein, including configurations that combine, omit, and/or add aspects and/or components.

As shown in FIG. 1, the system environment includes one or more user equipment 102 configured to communicate wirelessly, such as via an access network, with a network 106. Although the user equipment may be configured in a variety of different manners, the user equipment may be embodied as a mobile terminal, such as a portable digital assistant (PDA), mobile phone, smartphone, pager, mobile television, gaming device, laptop computer, camera, tablet computer, communicator, pad, headset, touch surface, video recorder, audio/video player, radio, electronic book, positioning device (for example, global positioning system (GPS) device), or any combination of the aforementioned, and other types of voice and text and multi-modal communications systems. System environment 100, as depicted in FIG. 1, also includes one or more access points 104a and 104b, such as base stations, node Bs, evolved Node Bs (eNB), or the like, for example. A cellular access point, such as a base station, may define and service one or more cells. The access points may, in turn, be in communication with a network 106, such as a core network via a gateway, such that the access points establish cellular radio access networks by which the user equipment 102 may communicate with the network. The system environment 100 of FIG. 1 may include a plurality of different cellular radio access networks including, for example, a 5G radio access network, an LTE radio access network, a UMTS (universal mobile telecommunications system) radio access network, etc. In some example implementations, equipment and other infrastructure associated with multiple different cellular radio access networks may be located at or near structures and/or other equipment associated with a particular access point, such as access point 104a and 104b.

In some implementations of system environment 100, the cellular radio access networks serviced by access points 104a, 104b, and any other access points in a given area are identical, in the sense that as user equipment 102 moves from an area serviced by access point 104a to an area serviced by access point 104b, the user equipment 102 is able to access the network 106 via a radio access network provided by the same vendor across access points. Although not shown, the system may also include a controller associated with one or more of the cellular access points, such as base stations for example, so as to facilitate operation of the access points and management of the user equipment 102 in communication therewith. As shown in FIG. 1, a system may also include one or more wireless local area networks (WLANs), each of which may be serviced by a WLAN access point 108 configured to establish wireless communications with the user equipment. As such, the user equipment may communicate with the network via a WLAN access point as shown in solid lines in FIG. 1, or, alternatively, via a cellular access point as shown in dashed lines. The radio access networks as well as the core networks may consist of additional network elements as routers, switches, servers, gateways, and/or controllers.

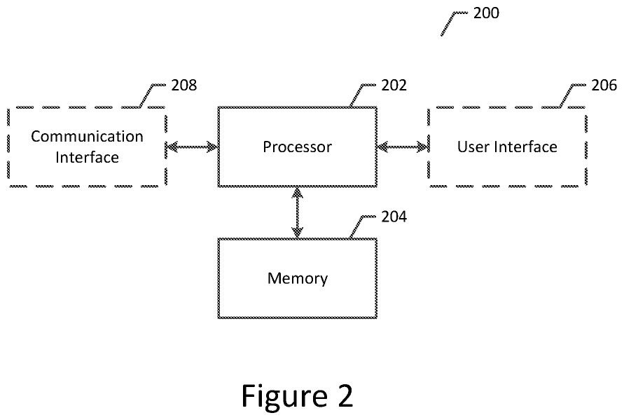

Based upon the receipt and/or selection of an IP address associated with a network component, such as a NodeB or gateway, for example, that is configured to have multiple IP addresses, packets from one of a plurality of pieces of user equipment can be directed to and/or through a network component in a manner that tends to balance the load experienced by the multiple cores and/or processors of the network component, such that any given individual core is unlikely to be overloaded when other cores or processors of the network component have significant unused capacity. In this regard, distribution of packets amongst the cores or other processors of a network component within a network environment can be accomplished by an apparatus 200 as depicted in FIG. 2. The apparatus may be embodied by and/or incorporated into one or more UEs, such as user equipment 102, or any of the other devices discussed with respect to FIG. 1, such as access points 104a and/or 104b, one or more of WLAN access points 108, and/or devices that may be incorporated or otherwise associated with system environment 100. Alternatively, the apparatus 200 may be embodied by another device, external to such devices. For example, the apparatus may be embodied by a computing device, such as a personal computer, a computer workstation, a server or the like, or by any of various mobile computing devices, such as a mobile terminal, a smartphone, a tablet computer, or the like, for example.

Regardless of the manner in which the apparatus 200 is embodied, the apparatus of an example embodiment is configured to include or otherwise be in communication with a processor 202 and a memory device 204 and optionally the user interface 206 and/or a communication interface 208. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the apparatus 200 may be embodied by a computing device. However, in some embodiments, the apparatus may be embodied as a chip or chip set. In other words, the apparatus may comprise one or more physical packages (for example, chips) including materials, components and/or wires on a structural assembly (for example, a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 202 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 202 may be configured to execute instructions stored in the memory device 204 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the apparatus 200 may optionally include a user interface 206 that may, in turn, be in communication with the processor 202 to provide output to the user and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (for example, software and/or firmware) stored on a memory accessible to the processor (for example, memory device 204, and/or the like).

The apparatus 200 may optionally also include the communication interface 208. The communication interface may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

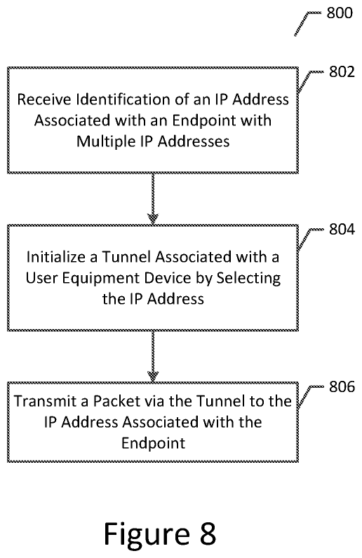

Referring now to FIG. 8, the operations performed by the apparatus 200 of FIG. 2 in accordance with an example embodiment of the present invention are depicted as an example process flow 800. In this regard, the apparatus includes means, such as the processor 202, the memory 204, the user interface 206, the communication interface 208 or the like, for receiving an identification of an IP address, wherein the IP address is one of a plurality of IP addresses associated with an endpoint within a network; initializing a tunnel associated with a user equipment device, wherein initializing the tunnel comprises selecting the IP address; and transmitting a packet via the tunnel to the IP address associated with the endpoint within the network. As such, the apparatus is generally capable of providing for the selection of an endpoint IP address for a tunnel associated with a user equipment or a flow as discussed and otherwise contemplated herein.

The apparatus includes means, such as the processor 202, the memory 204, the communication interface 208 or the like, receiving an identification of an IP address, wherein the IP address is one of a plurality of IP addresses associated with an endpoint within a network. For example, and with reference to block 802 of FIG. 8, the process 800 includes the receipt of an identification of an IP address associated with an endpoint, wherein the endpoint is configured with multiple IP addresses. Any endpoint within a network may be used in example implementations of block 802. In some example implementations, the endpoint is a NodeB established within a network. In some such example implementations, and in other example implementations, the endpoint may be a gateway within a network, such as a user plane gateway.

Any approach to transmitting and/or receiving an identification of an IP address from amongst a plurality of IP addresses associated with an endpoint within a network may be used in implementations of block 802. In some advantageous example implementations, receiving an identification of an IP address, wherein the IP address is one of a plurality of IP addresses associated with an endpoint within a network comprises calculating an IP address based at least in part on an identifier associated with a user equipment device or a flow. For example, a hash function may take into account an identification of a piece of user equipment and/or flow to ensure that packets associated with the particular piece of user equipment and/or flow are always directed to a particular IP address during a given session. Such an approach may be particularly advantageous in situations where maintaining the order of the packets associated with a particular piece of user equipment and/or flow tends to result in improved user data rates experienced by the piece of user equipment and/or otherwise tends to improve system performance.

The apparatus also includes means, such as the processor 202, the memory 204, the communication interface 208 or the like for initializing a tunnel associated with a user equipment device, wherein initializing the tunnel comprises selecting the IP address. For example, and with reference to FIG. 8, the process 800 contemplates passing from block 802, wherein the identification of the IP address is received, to block 804, which includes initializing a tunnel associated with a user equipment device by selecting the IP address. Any approach to initializing a tunnel and/or selecting an IP address, including but not limited to those discussed or otherwise contemplated herein, may be used in connection with example implementations of block 804. For example, in some example implementations, selecting the IP address comprising applying a load balancing selection protocol. In some such example implementations, the endpoint and/or other network device is capable of detecting and/or otherwise determining the loads experienced by the cores and/or other processors associated with a given network component, and determining which IP address from amongst a plurality of IP addresses associated with that network component are assigned to each core and/or other processor. Consequently, a set of predetermined load-balancing rules may be applied, such that tunnels are established in a manner that tends to cause the packets and/or other network traffic to be distributed equally or near-equally amongst each core or other processor in the given network component. One such set of rules may be applied to cause each new tunnel to be established with the core that is experiencing and/or has experienced the lowest level of traffic (and/or has the highest available capacity) within a predetermined time frame.

In some example implementations of block 804, selecting the IP address may include the application of a hash function, including but not limited to any of the hash functions disclosed or otherwise contemplated herein. In some such example implementations, the hash function may be based at least in part on a UE identifier and allow for the selection of a particular IP address associated with a NodeB or gateway based on the calculated hash value.

In some example implementations of block 804, selecting the IP address includes applying a round-robin selection protocol. In some such example implementations, the IP addresses associated with a particular network component are set in a predetermined order, and the endpoint and/or other network device is capable of detecting and/or otherwise establishing which IP address was most recently used during the initialization of a tunnel. Consequently, when initializing a subsequent tunnel, the next IP address in the predetermined order, such that new tunnels are initiated iteratively across the various IP addresses associated with a given network component, such that the load experienced by the cores and/or other processors associated with each IP tend to balance over time.

The apparatus also includes means, such as the processor 202, the memory 204, the communication interface 208 or the like for transmitting a packet via the tunnel to the IP address associated with the endpoint within the network. Implementations of example embodiments of the invention are directed to the efficient distribution of tunneled packets associated with multiple pieces of user equipment across central processing unit cores associated with network components, and contemplate network components, such as a NodeB and/or a gateway for example, that are associated with multiple IP addresses. As such, and with reference to block 806 of FIG. 4, for example, example implementations of process 800 include transmitting a packet via the initialized tunnel to the IP address associated with the particular network endpoint. Any approach to transmitting a packet via a tunnel to a particular IP address may be used in example implementations of block 806. In some advantageous example implementation, transmitting a packet via the tunnel to the IP address associated with the endpoint within the network comprises applying an identifying header field, wherein the identifying header field comprises at least one of an identification of the IP address, an identification of a port, and/or an identification of an IPv6 flow label to the packet.

While many of the examples are presented in terms associated with the transmission of one or more packets, it will be appreciated that the techniques and processes used herein may be similarly implemented on the receiving end of such packets. For example, upon receipt of a packet at a network component, the packet may be inspected to ensure that a source IP address and/or a destination IP address of the packet properly correspond to a particular IP address selected from amongst a set of multiple IP addresses. Consequently, at least some network components that are used in connection with example implementations may be configured such that they do not actively select one or more IP address from amongst a plurality of potential IP addresses, but instead verify the validity of IP address chosen by other network components for use in connection with the transmissions described and/or otherwise contemplated herein.

As described above, FIG. 8 illustrates a flowchart of an apparatus 200, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 204 of an apparatus employing an embodiment of the present invention and executed by the processor 202 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for selecting an endpoint internet protocol (IP) address for a tunnel associated with a user equipment or a flow, the method comprising:
receiving an identification of an IP address, wherein the IP address is one of a plurality of IP addresses associated with an endpoint within a network;
initializing a tunnel associated with a user equipment device, wherein initializing the tunnel comprises selecting the IP address; and
transmitting a packet via the tunnel to the IP address associated with the endpoint within the network.

2. A method according to claim 1, wherein the endpoint is a NodeB.

3. A method according to claim 1, wherein the endpoint is a user plane gateway.

4. A method according to claim 1, wherein selecting the IP address comprises applying a load balancing selection protocol.

5. A method according to claim 1, wherein selecting the IP address comprises applying a hash function.

6. A method according to claim 1, wherein selecting the IP address comprises applying a round robin selection protocol.

7. A method according to claim 1 wherein receiving an identification of an IP address that is one of a plurality of IP addresses associated with an endpoint within a network comprises calculating an IP address based at least in part on an identifier associated with a user equipment or a flow.

8. A method according to claim 1, wherein transmitting a packet via the tunnel to the IP address associated with the endpoint within the network comprises applying an identifying header field, wherein the identifying header field comprises at least one of an identification of an IP address, an identification of a port, or an identification of an IPv6 flow label.

9. An apparatus comprising at least one processor and at least one memory storing computer program code, the at least one memory and the computer program code configured to, with the processor, cause the apparatus to at least:
receive an identification of an internet protocol (IP) address, wherein the IP address is one of a plurality of IP addresses associated with an endpoint within a network;
initialize a tunnel associated with a user equipment device, wherein initialize the tunnel comprises selecting the IP address; and
transmit a packet via the tunnel to the IP address associated with the endpoint within the network.

10. An apparatus according to claim 9, wherein the endpoint is a NodeB.

11. An apparatus according to claim 9, wherein the endpoint is a user plane gateway.

12. An apparatus according to claim 9, wherein selecting the IP address comprises applying a load balancing selection protocol.

13. An apparatus according to claim 9, wherein selecting the IP address comprises applying a hash function.

14. An apparatus according to claim 9, wherein selecting the IP address comprises applying a round robin selection protocol.

15. An apparatus according to claim 9, wherein receiving an identification of an IP address that is one of a plurality of IP addresses associated with an endpoint within a network comprises calculating an IP address based at least in part on an identifier associated with the user equipment device or a flow.

16. An apparatus according to claim 9, wherein transmitting a packet via the tunnel to the IP address associated with the endpoint within the network comprises applying an identifying header field, wherein the identifying header field comprises at least one of an identification of an IP address, an identification of a port, or an identification of an IPv6 flow label.

17. A computer program product comprising at least one non-transitory computer-readable storage medium having computer-executable program code instructions stored therein, the computer-executable program code instructions comprising program code instructions configured to:
receive an identification of an internet protocol (IP) address, wherein the IP address is one of a plurality of IP addresses associated with an endpoint within a network;
initialize a tunnel associated with a user equipment device, wherein initialize the tunnel comprises selecting the IP address; and
transmit a packet via the tunnel to the IP address associated with the endpoint within the network.

18. A computer program product according to claim 17, wherein the endpoint is a NodeB.

19. A computer program product according to claim 17, wherein the endpoint is a user plane gateway.

20. A computer program product according to claim 17, wherein selecting the IP address comprises applying a load balancing selection protocol.

21.-24. (canceled)
